(19) United States
(12) Patent Application Publication
(10) Pub. No.: US 2025/0383274 A1
(43) Pub. Date: Dec. 18, 2025

(54) TESTING DEVICE FOR MATERIAL MECHANICAL PROPERTY TESTING IN A PRESSURIZED ENVIRONMENT

(71) Applicant: Da-Ming Duan, Calgary (CA)

(72) Inventors: Da-Ming Duan, Calgary (CA); Shi-Wei Vicky Duan, Calgary (CA)

(21) Appl. No.: 19/024,358

(22) Filed: Jan. 16, 2025

(30) Foreign Application Priority Data
Jun. 13, 2024 (CN) 202421344789.8

(51) Int. Cl. G01N 3/12

(52) U.S. Cl. CPC G01N 3/12; G01N 2203/0048

(57) ABSTRACT

A testing device for measuring mechanical properties of a material specimen in a pressurized testing environment. The testing device comprises a first fluid chamber separated from a second fluid chamber by a first disc diaphragm; a first fluid balancing chamber separated from a second fluid balancing chamber by a second disc diaphragm; a loading rod extending through a wall of the first fluid chamber and the first disc diaphragm for applying a load on the material specimen in the second fluid chamber. The first fluid chamber is in communication with the first fluid balancing chamber and the second fluid chamber is in communication with the second fluid balancing chamber. A sealing assembly is fixedly mounted together with the loading rod and the first disc diaphragm to seal the first fluid chamber from the second fluid chamber.

### CROSS-REFERENCE TO RELATED APPLICATION

This application claims priority to Chinese Patent Utility Model application No. 202421344789.8 filed on Jun. 13, 2024, which is incorporated herein by reference in its entirety.

### TECHNICAL FIELD

This application relates to the technical field of testing devices for testing mechanical properties of a material specimen; in particular, this application relates to testing devices having high-pressure chambers for testing the properties of materials in a pressurized environment.

### BACKGROUND

Mechanical property tests of engineering materials, such as tensile, compressive and fracture toughness testing, are usually carried out in a laboratory using a testing machine to load the material specimen. The mechanical properties of the materials are measured and tested in a specific environment or agent.

When a test is conducted to investigate the specific environmental effects on the mechanical properties of a material, the usual practice is to provide an environmental testing chamber surrounding the loading part of the testing machine, and place the material specimen and loading device within the environmental testing chamber. During the testing, the environmental agent, temperature and pressure in the testing chamber may be controlled to test the material specimen under particular environmental conditions.

With the emergence of the use of hydrogen as a clean energy fuel, there is an increasing need for testing materials in high-pressure hydrogen gas environments. For example, hydrogen embrittlement of metals and other materials is a known issue, which may impact the design of equipment used in the production, transport and utilization of hydrogen gas. To understand the hydrogen effect, material testing needs to be conducted with the material specimen being loaded in a high-pressure hydrogen environment, and such testing may need to be conducted over extended periods of time, for example, 1,000 hours or more. Challenges exist for the existing art of material testing technologies in at least the following three aspects. Firstly, as hydrogen gas is comprised of the smallest molecule, it is difficult to prevent leaking of hydrogen gas under high pressure from a testing chamber, because the loading rod typically passes through the wall of the pressurized testing chamber and complete sealing is not possible. Secondly, the lubrication oil applied to the contact surfaces between the loading rod and the testing chamber tends to contaminate the pressurized hydrogen testing environment. Thirdly, to prevent hydrogen gas from leaking, the sealing at the loading rod contact area has to be very tight, which may result in high friction forces imposed on the loading rod when the loading rod is moving. The friction may affect the accuracy of the testing results, and may even result in failure of the measurement, as it is difficult to accurately measure the force that the loading rod is applying to the material specimen being tested. There is therefore a need to improve the existing art and to develop new technologies.

U.S. Pat. No. 8,444,935 describes a sample testing system including a pair of fluid chambers with each chamber separated by a diaphragm. However the system does not disclose a loading rod passing through the diaphragm and an upper wall of the fluid chamber for applying a force to the material specimen.

### SUMMARY

In one aspect of the present disclosure, an improved testing device is provided for testing the mechanical properties of material specimens in a pressurized testing environment. In some embodiments, the testing device comprises a first fluid chamber for containing a first fluid; a second fluid chamber for containing a second fluid to provide the pressurized testing environment; a first disc diaphragm separating the first fluid chamber from the second fluid chamber, and fixedly mounted together with the first fluid chamber and the second fluid chamber; a first fluid balancing chamber arranged adjacent to and in fluid communication with the first fluid chamber; a second fluid balancing chamber in fluid communication with the second fluid chamber; a second disc diaphragm separating the first fluid balancing chamber from the second fluid balancing chamber, and fixedly mounted together with the first fluid balancing chamber and the second fluid balancing chamber; a loading rod extending through a wall of the first fluid chamber and the first disc diaphragm for applying a predetermined force on the material specimen in the second fluid chamber; a sealing element fixedly coupled to the wall of the first fluid chamber to allow the loading rod to slide through the sealing element; and a sealing assembly fixedly mounted together with the loading rod and the first disc diaphragm to seal the first fluid chamber from the second fluid chamber. Furthermore, the first fluid chamber is in fluid communication with the first fluid balancing chamber, and the second fluid chamber, comprising the testing chamber, is in fluid communication with the second fluid balancing chamber.

The testing device of the present disclosure provides a design having a stable, high-pressure environment for measuring mechanical properties of the material specimen with a design of two flexible disc diaphragms and four chambers. The problems of prior art, such as poor sealing, prone leakage and contamination of testing environment agent, and the inaccurate transmission of a load onto a material specimen caused by frictional forces acting on the loading rod, are addressed by the testing device of the present disclosure.

As the first disc diaphragm separates the first fluid chamber from the second fluid chamber, and the sealing assembly is fixedly mounted together with the loading rod and the first disc diaphragm, the second fluid chamber, also referred to herein as the testing chamber, is completely isolated from the first fluid chamber and is well sealed. This configuration not only prevents the second fluid, also referred to as the testing environment agent such as hydrogen gas from leaking, but also effectively prevents the first fluid, such as hydraulic or lubrication oil in the first chamber, from leaking into the testing chamber. This avoids the contamination of the testing chamber by the hydraulic oil, lubrication oil or other fluids. As used herein, it will be appreciated by a person skilled in the art that either lubrication oil or hydraulic oil may be suitable for use in the first fluid chamber and the corresponding first fluid balancing chamber of the device, and that where the term “hydraulic oil” is used in this description in describing an illustrative example of the operation of the testing device, that “lubrication oil” may be substituted in place of the hydraulic oil. Likewise, whenever the term “lubrication oil” is used herein to describe an illustrative example of the operation of the testing device, “hydraulic oil” may be substituted in the place of the lubrication oil in such examples.

The configuration of the second disc diaphragm that separates the first fluid balancing chamber and the second fluid balancing is capable of synchronously deforming in response to the pressure changes in the first fluid chamber and the second fluid chamber. Thus, the pressure fluctuation and imbalance in the first fluid chamber and the second fluid chamber may be avoided, which allows the load applied to the material specimen by the loading rod to be accurately determined, resulting in the increased accuracy of the measurement of the mechanical properties of the specimen being tested.

In one aspect of the present disclosure, a testing device for testing mechanical properties of a material specimen in a pressurized testing environment comprises: a first fluid chamber for containing a first fluid; a second fluid chamber for containing a second fluid to provide the pressurized testing environment; a first disc diaphragm separating the first fluid chamber from the second fluid chamber and fixedly mounted together with the first fluid chamber and the second fluid chamber; a first fluid balancing chamber in fluid communication with the first fluid chamber; a second fluid balancing chamber in fluid communication with the second fluid chamber; a second disc diaphragm separating the first fluid balancing chamber from the second fluid balancing chamber and fixedly mounted together with the first fluid balancing chamber and the second fluid balancing chamber; a loading rod extending through a wall of the first fluid chamber and the first disc diaphragm for applying a predetermined force on the material specimen in the second fluid chamber; a sealing element fixedly coupled to the wall of the first fluid chamber to allow the loading rod to slide through the sealing element; and a sealing assembly fixedly mounted together with the loading rod and the first disc diaphragm to seal the first fluid chamber from the second fluid chamber.

In some embodiments of the testing device, the sealing assembly comprises: a lower sealing disc located below the first disc diaphragm and fixedly mounted to the loading rod; at least one first sealing gasket mounted between the lower sealing disc and the first disc diaphragm; an upper sealing disc located above the first disc diaphragm and fixedly mounted together with the lower sealing disc and the first disc diaphragm; and at least one second sealing gasket mounted between the upper sealing disc and the first disc diaphragm.

In some embodiments, the lower sealing disc is welded to the loading rod. In other embodiments, the lower sealing disc is manufactured together with the loading rod as one piece. In some embodiments, the upper sealing disc, the first disc diaphragm and the lower sealing disc are fixedly mounted together by a plurality of fasteners.

In some embodiments, each of the at least one first sealing gasket and the at least one second sealing gasket comprises an inner annular sealing gasket located between the plurality of fasteners and the loading rod and an outer annular sealing gasket located between the plurality of fasteners and an outer edge of the upper and lower sealing discs.

In some embodiments of the testing device, the first fluid is an oil and the second fluid is hydrogen gas. In some embodiments, the second fluid chamber is located below the first fluid chamber, and the second fluid balancing chamber is located below the first fluid balancing chamber. In some embodiments, each of the first fluid chamber, the second fluid chamber, the first fluid balancing chamber and the second fluid balancing chamber are cylindrical in shape.

In some embodiments of the testing device, a specimen support structure is fixedly mounted onto an inner surface of a wall of the second fluid chamber. In some embodiments, the testing device further comprises a first connecting conduit fluidly connecting the first fluid chamber to the first fluid balancing chamber, and a second connecting conduit connecting the second fluid chamber to the second fluid balancing chamber. In some embodiments, a first inlet conduit is coupled to an inlet of the first fluid chamber and a first outlet conduit is coupled to an outlet of the first fluid balancing chamber. In some embodiments, a second inlet conduit coupled to an inlet of the second fluid chamber and a second outlet conduit coupled to an outlet of the second fluid balancing chamber. In some embodiments, each of the first inlet conduit and the first outlet conduit include a valve for controlling the flow of the first fluid through the first inlet conduit and the first outlet conduit. In some embodiments, each of the second inlet conduit and the second outlet conduit include a valve for controlling the flow of the second fluid through the second inlet conduit and the second outlet conduit.

In some embodiments of the testing device, each of the first fluid chamber, the first fluid balancing chamber, the second fluid chamber and the second fluid balancing chamber has a flange extended outwardly from its chamber body so that the first fluid chamber is fixedly mounted together with the second fluid chamber by a first plurality of chamber fasteners inserted through the first and second fluid chambers' corresponding flanges, and the first fluid balancing chamber is fixedly mounted together with the second fluid balancing chamber by a second plurality of chamber fasteners inserted through the first and second fluid balancing chambers' corresponding flanges.

In some embodiments of the testing device, at least one diaphragm sealing gasket is sandwiched between each of the first disc diaphragm and the second disc diaphragm and the corresponding first or second fluid chambers or the corresponding first or second fluid balancing chambers.

In some embodiments, a plurality of supporting legs for stably supporting at least the second fluid chamber and the second fluid balancing chamber on a surface. In some embodiments, at least one connecting rod is for stably connecting at least the second fluid chamber on a surface of a material mechanical testing machine.

### BRIEF DESCRIPTION OF THE DRAWINGS

Embodiments of the testing device of the present disclosure will be described herein, with reference to the accompanying drawings:

FIG. 1 is an isometric view of an embodiment of a testing device, in accordance with the present disclosure;

FIG. 2 is an isometric, sectional view of the testing device of FIG. 1;

FIG. 3 is an isometric, sectional view of a portion of the testing device of FIG. 1, showing a first fluid chamber and a second fluid chamber;

FIG. 4 is an isometric, sectional view of another portion of the testing device of FIG. 1, showing a first fluid balancing chamber and a second fluid balancing chamber;

FIG. 5A is an enlarged sectional view taken along line A-A of FIG. 2, showing a sealing assembly of the testing device of FIG. 1;

FIG. 5B is a sectional view of another embodiment of the sealing assembly of the testing device, in accordance with the present disclosure;

FIGS. 6A and 6B are top perspective views of an embodiment of the upper and lower sealing discs used in the sealing assembly of FIG. 5; and

FIG. 7 is a cross-sectional view of a second fluid chamber with an embodiment of a support structure within the chamber for supporting a material specimen;

FIG. 8 is a cross-sectional view of a second fluid chamber with another embodiment of a support structure within the chamber for supporting a material specimen.

### DETAILED DESCRIPTION

The following list shows all components and their corresponding reference numerals used in all the figures of an exemplary embodiment of the present disclosure, which will be discussed in detail:
1, first fluid chamber; 2, second fluid chamber; 3, first fluid balancing chamber; 4, second fluid balancing chamber; 5, first disc diaphragm; 6, second disc diaphragm; 7, loading rod; 8, support structure; 9, material specimen; 10, first connecting hose; 11, second connecting hose; 12, connecting head; 13, supporting leg; 14, connecting rod; 15, foot pad; 16, first chamber bolt array; 17, second chamber bolt array; 18, first fluid inlet pipe; 19, second fluid inlet pipe; 20, first fluid outlet pipe; 21, second fluid outlet pipe; 22, sealing ring; 23, upper sealing disc; 23a, outer edge of the upper sealing disc; 24, lower sealing disc; 24a, outer edge of the lower sealing disc; 25, bolt array; 26, first diaphragm sealing gasket; 27, second diaphragm sealing gasket; 28a, inner sealing gasket; 28b, outer sealing gasket; 30, sealing assembly; 31, chamber wall flange; 32, support grip; 34, connecting rod.

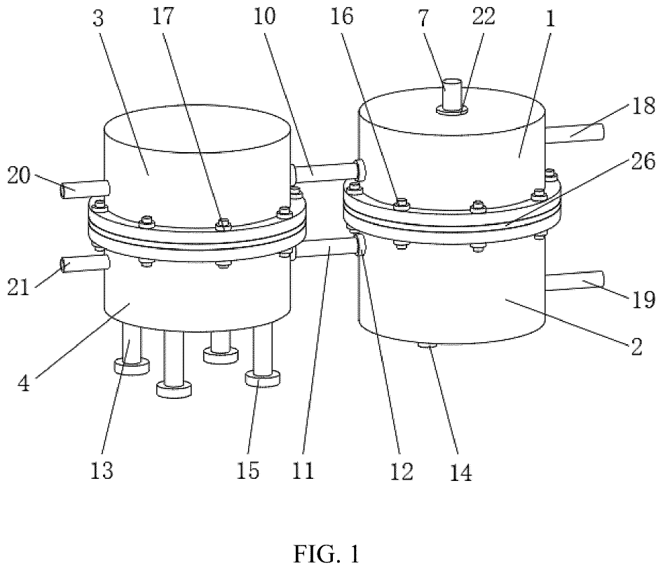

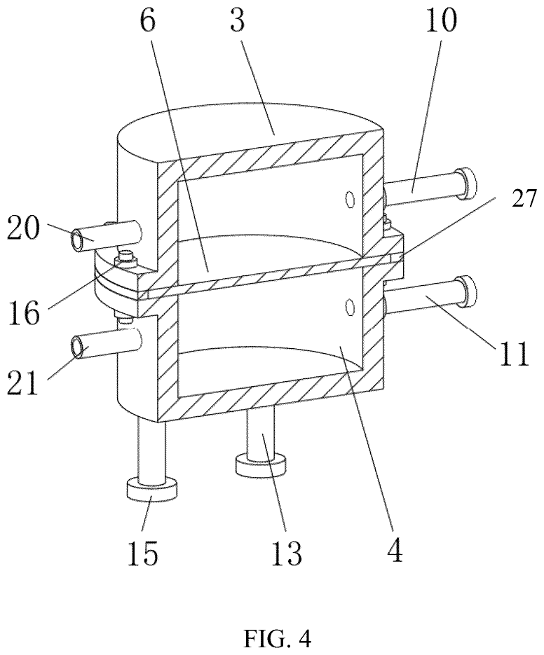

FIGS. 1-8 illustrate embodiments of the testing device for testing mechanical properties of a material specimen in a pressurized testing environment. The mechanical properties of a material that may be tested using the testing device described herein include, but are not limited to, tensile strength, compressive strength, bending, hardness, fatigue, fracture toughness, etc.

With reference to FIGS. 1 to 5, the testing device includes a high-pressure testing chamber. Within the testing chamber, a material specimen is supported, and a loading rod is used to apply forces to the material specimen to measure its mechanical properties. In particular the testing device comprises a first fluid chamber 1 for containing a first fluid; a second fluid chamber 2 for containing a second fluid; a first disc diaphragm 5 separating the first fluid chamber 1 from the second fluid chamber 2; a first fluid balancing chamber 3 arranged adjacent to and in fluid communication with the first fluid chamber 1; a second fluid balancing chamber 4 in fluid communication with the second fluid chamber 2; a second disc diaphragm 6 separating the first fluid balancing chamber 3 from the second fluid balancing chamber 4. A loading rod 7 extending through a wall of the first fluid chamber 1 and the first disc diaphragm 5 for applying a predetermined force on the material specimen 9. A sealing element 22 such as a sealing ring is fixedly coupled to the wall of the first fluid chamber 1 to allow the loading rod 7 to slide through the sealing element 22. A sealing assembly 30 is fixedly mounted together with the loading rod 7 and the first disc diaphragm 5 to seal the first fluid chamber from the second fluid chamber.

In this embodiment, the first fluid chamber 1 and the first fluid balancing chamber 3 contain a first fluid; in an exemplary embodiment, the first fluid may be hydraulic or lubrication oil. The second fluid chamber 2 and the second fluid balancing chamber 4 contain a second fluid for providing a pressurized material testing environment for testing the properties of a material. In an exemplary embodiment of the testing device, the second fluid may be hydrogen gas, although it will be appreciated that other testing fluids such as other gases or liquids may also be used in the testing device, in order to test the mechanical properties of a material in a specific environment. Throughout this description, the example of using hydraulic or lubrication oil as the first fluid and hydrogen gas as the second fluid, to provide for material testing in a pressurized hydrogen gas environment, will be used to describe the principles and operation of the novel testing device; however, the example of using hydraulic or lubrication oil and hydrogen gas in the testing device is not intended to be limiting, and it will be appreciated that other fluids may be used as the first and second fluids in the testing device. The material specimen 9 to be tested may be placed in the hydrogen gas environment in the second fluid chamber 2 under a predetermined pressure for testing of different mechanical properties. This predetermined pressure, for example, may be up to 1.45 ksi or 10 MPa, which is a typical pressure range that is used for testing the material properties of a specimen for steel gas pipelines. However, the aforementioned pressure range is not intended to be limiting, and it will be appreciated that the testing device disclosed herein may be configured for testing at higher pressures if required.

In one aspect, the second fluid chamber 2 containing the hydrogen gas is located below the first fluid chamber 1 containing the hydraulic oil (or lubrication oil). The first fluid balancing chamber 3 that is in fluid communication with the first fluid chamber 1 is located adjacent to the first fluid chamber 1. The second fluid balancing chamber 4 that is in communication with the second fluid chamber 2 is located below the first fluid balancing chamber 3. In the illustrated embodiments shown in FIGS. 1 to 5, the first fluid chamber 1, the second fluid chamber 2, the first fluid balancing chamber 3 and the second fluid balancing chamber 4 are each cylindrical in shape. Advantageously, pressurized chambers that are cylindrical provides for a uniform stress acting on the cylindrical chamber wall. However, persons skilled in the art would understand that these chambers are not limited to cylindrical geometries; chambers having other shapes, including spheres, cuboids, frustoconical, etc. may also be used.

The loading rod 7 extends through a hole, preferably at the center of an upper wall of the first fluid chamber 1. The sealing element 22 such as a conventional sealing ring as would be known to persons skilled in the art, is fixedly coupled to the hole in the upper wall of the first fluid chamber, and allows the loading rod 7 to slide through the sealing ring 22. This sealing ring 22 not only prevents the leakage of the lubricating or hydraulic oil, but also reduces the friction force between the sealing ring 22 and the loading rod 7, thereby enhancing the service life of the testing device and the accuracy of the measured load force applied by the loading rod 7.

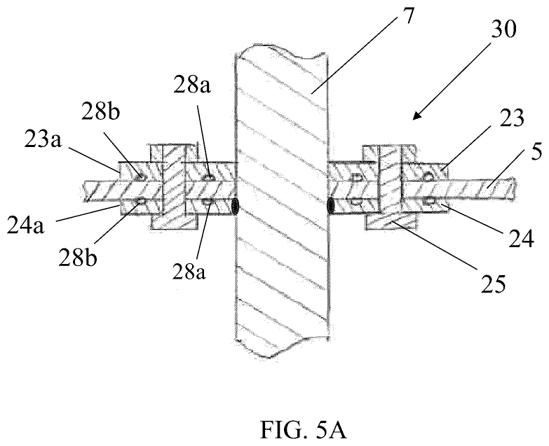

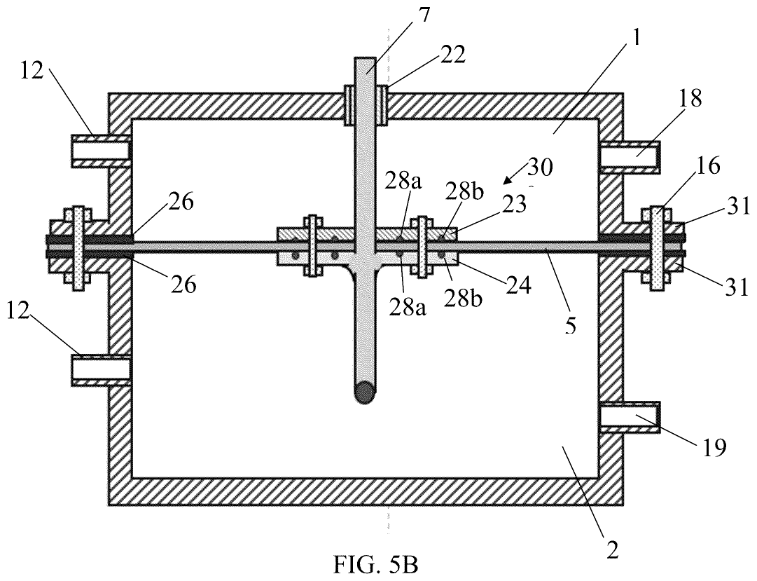

According to another aspect, the sealing assembly 30 as shown in FIG. 5 further provides sealing to the hydraulic oil in the first fluid chamber 1 and sealing to the hydrogen gas in the second fluid chamber 2 so that the hydraulic lubrication oil in the first fluid chamber 1 and the hydrogen gas in the second fluid chamber are isolated from one another. This sealing assembly 30 substantially prevents leakage of the hydraulic oil into the second fluid chamber 2, thereby preventing contamination of the testing environment within the second fluid chamber 2, and also prevents the hydrogen gas leaking from the second fluid chamber 2 into the first fluid chamber 1, thereby allowing the maintenance of a substantially consistent pressure in the testing chamber of the second fluid chamber 2 throughout the testing cycle.

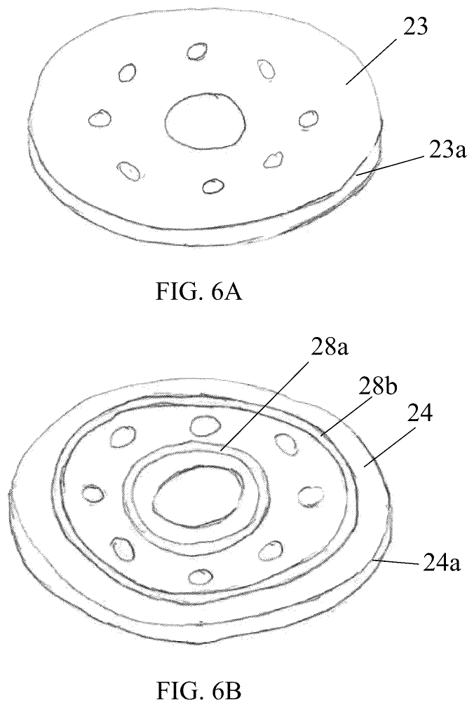

With reference to FIGS. 5A to 6B, the sealing assembly 30 may comprise a lower sealing disc 24 located below the first disc diaphragm and an upper sealing disc 23 located above the first disc diaphragm. The lower sealing disc 24 may be fixedly mounted to the loading rod 7, such as by welding. Alternatively, the lower sealing disc 24 may be manufactured together with the loading rod 7 as one piece. The lower sealing disc 24, the first disc diaphragm 5 and the upper sealing disc 23 are fixedly mounted together by a plurality of fasteners; for example, an annular array of bolts and sealing washers 25. At least one set of sealing gaskets 28a, 28b may be sandwiched between the lower sealing disc 24 and the first disc diaphragm 5, and at least a second set of sealing gaskets 28a, 28b may be mounted between the upper sealing disc 23 and the first disc diaphragm 5. For example, there may be one inner sealing gasket 28a located between the plurality of bolts 25 and the loading rod 7, and an outer sealing gasket 28b located between the plurality bolts 25 and the outer edges 23a, 24a of the upper and lower sealing discs 23, 24. A similar arrangement of sealing gaskets may be provided between the lower sealing disc 24 and the first disc diaphragm 5. The surface of each sealing disc 23, 24 which is positioned adjacent to the surface of the first disc diaphragm 5 may be provided with a pair of annular grooves (not shown) for receiving the inner and outer sealing gaskets 28a, 28b. As will be understood by a person skilled in the art, suitable diaphragms may be selected for use in the testing device disclosed herein, with the selection of a suitable diaphragm informed by the requirements of the predetermined pressure of the gas or other fluid to be used in the testing chamber 2. For example, not intended to be limiting, typical steel diaphragms designed for use in high pressure gas compressors may be selected for the first and the second disc diaphragms 5, 6. Diaphragms manufactured of materials other than steel may also be suitable for the application, depending on the requirements of the predetermined pressure, the chemical composition of the fluids to be used in the testing chamber 2 and the first fluid chamber 1, and other factors.

In some embodiments (not shown), the upper sealing disc 23 may be fixedly mounted to the loading rod 7, for example by welding or by manufacturing the upper sealing disc 23 and the loading rod 7 together to form a single piece, and the lower sealing disc 24 may be fixedly mounted together with the first disc diaphragm 5 and the upper sealing disc 23 using a plurality of fasteners 25. Regarding the sealing gaskets, in some embodiments (not shown), a single sealing gasket which covers both a portion of the surface of the sealing disc 23 or 24 between the plurality of fasteners 25 and the loading rod 7, as well as a portion of the surface of the sealing disc 23 or 24 and the outer edge 23a, 24a of the sealing disc, may be provided in place of two separate sealing gaskets 28a, 28b. It will be appreciated that any configuration of sealing gasket which provides sufficient sealing and fluid-tight isolation of the interface between the loading rod 7, the first disc diaphragm 5, and the second fluid chamber 2, and likewise a fluid-tight isolation of the interface between the loading rod 7, the first disc diaphragm 5, and the first fluid chamber 1, is intended to be included in the scope of the present disclosure. Regarding the plurality of fasteners 25, although the example of an array of bolts 25 and corresponding sealing washers is provided herein as an example of suitable fasteners, it will be appreciated that any fastener that is suitable for fixedly mounting the lower and upper sealing discs 24, 23 together with the loading rod 7 and the first disc diaphragm 5, in order to form a fluid-tight seal around the loading rod 7 and the diaphragm 5, as would be known to a person skilled in the art, is intended to be included in the scope of the present disclosure.

According to another aspect of the present disclosure, the testing device may further comprise a first connecting hose or conduit 10 connecting the first fluid chamber 1 with the first fluid balancing chamber 3, and a second connecting hose or conduit 11 connecting the second fluid chamber 2 with the second fluid balancing chamber 4. In embodiments utilizing hoses 10, 11, each of the two ends of the first connecting hose 10 and the second connecting hose 11 is respectively provided with a connecting head 12 having a sealing component so that the stability and sealing connection of the first connecting hose 10 and the second connecting hose 11 may be improved in communicating the lubricating hydraulic oil between the first fluid chamber 1 and the first fluid balancing chamber 3, as well as communicating the hydrogen gas between the second fluid chamber 2 and the second fluid balancing chamber 4.

In this embodiment, the testing device may further comprise a first fluid inlet conduit 18 coupled to an inlet of the first fluid chamber 1, to facilitate the transmission of the first fluid, such as a hydraulic or lubricating oil, into this chamber at a predetermined pressure. Similarly, a second fluid inlet conduit 19, such as a gas inlet pipe, may be coupled to an inlet of the second fluid chamber 2 to provide the second fluid to the second fluid chamber 2 to create the test environment at the same predetermined pressure. Thus, when the testing chamber is set up for testing a material specimen, the predetermined pressure of the second fluid chamber (or testing chamber) 2 and its corresponding fluid balancing chamber 4 is approximately equal to the predetermined pressure of the first fluid chamber 1 and its corresponding fluid balancing chamber 3.

In addition, the testing device may further comprise a first fluid outlet conduit 20 coupled to an outlet of the first fluid balancing chamber 3 so that the hydraulic oil may be easily discharged for pressure adjustment and be replaced with other fluids as needed. The testing device may also comprise a second fluid outlet conduit 21, such as a gas outlet pipe, coupled to an outlet of the second fluid balancing chamber 4 so that the pressure in the testing environment chamber, namely the second fluid chamber 2, may be adjusted or released as needed. It will be appreciated by those skilled in the art that suitable valves may be provided to each of the inlet and outlet conduits 18, 19, 20, 21 to effectively control the pressure and volume of the hydraulic oil (or other fluid) provided to the first fluid chamber 1 and the first fluid balancing chamber 3, and likewise to control the pressure and volume of the hydrogen gas (or other fluid) provided to the second fluid chamber 2 and the second fluid balancing chamber 4.

According to another aspect of the testing device, each of the first fluid chamber 1, the first fluid balancing chamber 3, the second fluid chamber 2 and the second fluid balancing chamber 4 may each have a flange 31 extending outwardly of the outer walls of the chamber, so that the first fluid chamber 1 may be fixedly mounted together with the first diaphragm 5 and the second fluid chamber 2 by a plurality of fasteners, such as a first bolt array with corresponding sealing washers 16, via their corresponding flanges 31. Likewise, the first fluid balancing chamber 3 may be fixedly mounted together with the second diaphragm 6 and the second fluid balancing chamber 4 by another plurality of fasteners, such as a second bolt array with corresponding sealing washers 17, via their corresponding flanges. The first disc diaphragm 5 is tightly sandwiched between the flanges of the first fluid chamber 1 and the second fluid chamber 2, and the second disc diaphragm 6 is tightly sandwiched between the flanges of the first fluid balancing chamber 3 and the second fluid balancing chamber 4. This configuration of assembling facilitates the fluid-tight, stable mounting together of the fluid chambers with their corresponding disc diaphragm. Furthermore, this configuration provides for the disassembly of the fluid chambers and their corresponding diaphragms to provide access to the material specimen supports within the second fluid chamber 2, in order to remove a material specimen or to position a new material specimen within the second fluid chamber 2 for material property testing.

Referring to FIGS. 1 and 5B, a pair of first diaphragm sealing gaskets 26 is aligned with the perimeter of each planar surface of the first disc diaphragm 5 and sandwiched between the flanges of the first fluid chamber 1 and the second fluid chamber 2, respectively. Likewise, a pair of second diaphragm sealing gaskets 27 is aligned with the perimeter of each planar surface of the second disc diaphragm 6 and sandwiched between the flanges of the first fluid balancing chamber 3 and the second fluid balancing chamber 4. These diaphragm sealing gaskets further provide fluid-tight sealing of each of the chambers and prevent the leakage of the oil, gas or other fluids from each chamber.

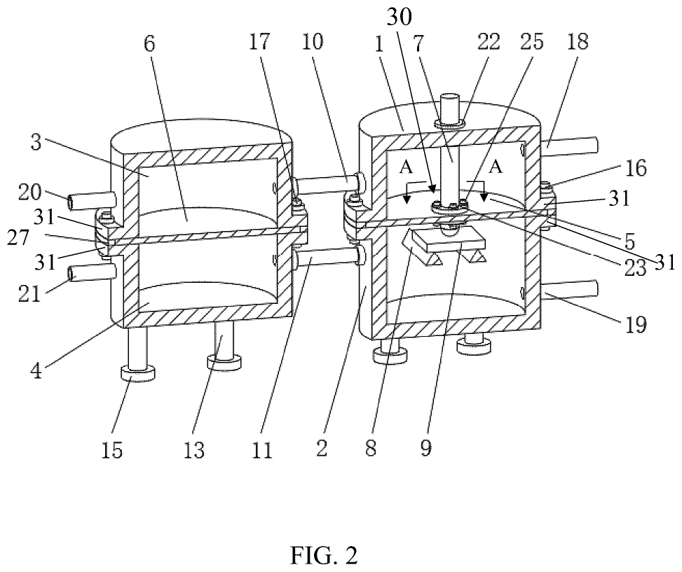

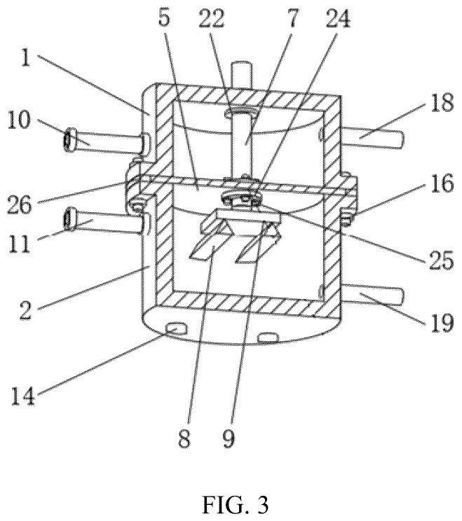

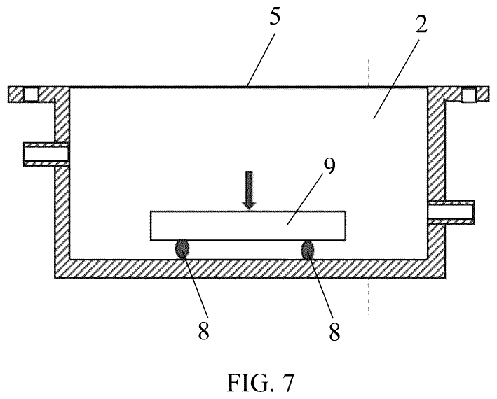

According to another aspect of the present disclosure, a support structure 8 is provided in the second fluid chamber 2, otherwise referred to herein as the testing chamber, to support the material specimen 9. In some embodiments, such as illustrated in FIGS. 2 and 3, the support structure 8 may include two separate parallel arms fixedly mounted and spaced apart on an inner surface of a side wall of the second fluid chamber 2. This configuration of the support structure 8 is for a bending test, in which forces are applied to the center of material specimen 9 by the loading rod 7. The opposite ends of the material specimen 9 are supported by the two spaced-apart arms of the support structure 8. In some embodiments, the support structure 8 may comprise two spaced apart supports mounted to the inner surface of a bottom wall of the second fluid chamber 2. Similar to the support structure shown in FIGS. 2 and 3, the support structure 8 shown in FIG. 7 is for bending tests wherein forces are applied to the material specimen 9 in the direction indicated by the arrow shown in FIG. 7 by the loading rod 7 (not shown).

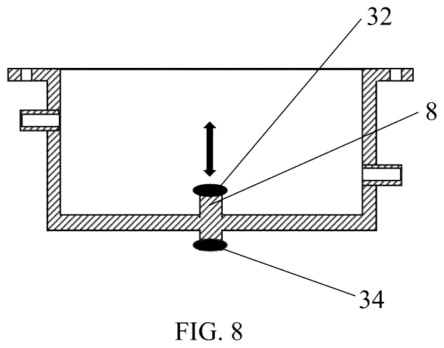

In other embodiments, the support structure 8 may be mounted to the inner surface of a bottom wall of the second fluid chamber 2 and include a specimen grip 32, as shown in FIG. 8. The specimen grip 32 may hold the material specimen 9, and a grip on the loading rod 7 (not shown) may be attached to an opposite side of the material specimen 9, so that either compression or tension loads may be applied by the loading rod 7 to the material specimen 9. The directions of the compression and the tension loads are indicated by the arrow shown in FIG. 8.

With reference to FIGS. 1 and 8, according to a further aspect, the testing device may comprise a plurality of supporting legs 13 under the second fluid chamber 2 and the second fluid balancing chamber 4 to support the testing device. A foot pad 15 may be placed under each supporting leg 13. The foot pad 15 may be made from materials with high friction coefficients, such as rubber, for increasing the friction force between the testing device and the ground, thus enhancing the stability of the device. The configuration of the supporting legs 13 and the foot pads 15 may provide sufficient support to the testing device and make it easy to be disassembled and moved to other locations. Alternatively, one or more connecting rods, 14 or 34, may be coupled to the bottom of the second fluid chamber 2 for stably mounting the bottom of the second fluid chamber within another device. For example, an existing material mechanical testing device may include corresponding connectors for receiving the one or more connecting rods 14, 34 of the testing device, such that the first and second fluid chambers 1, 2 may be mounted within the support frame of the existing material mechanical testing device. In such configurations, the loading equipment of the existing material mechanical testing device may be attached to the loading rod 7, thereby converting the existing material mechanical testing device into a testing device configured for testing material specimens in a pressurized environment.

Although the examples of the testing device, described and illustrated herein, show that each of the first fluid chamber 1 and corresponding first fluid balancing chamber 3 are positioned above the second fluid chamber 2 (which comprises the testing chamber) and the corresponding second fluid balancing chamber 4, it will be appreciated that the relative positions of these chambers may be in different configurations. For example, not intended to be limiting, the second fluid chamber 2 (and corresponding fluid balancing chamber 4) may each be positioned above the first fluid chamber 1 (and corresponding fluid balancing chamber 3), with the loading rod 7 entering the first fluid chamber 1 from the lower wall (or floor) of the first fluid chamber 1 and travelling in an upwards direction towards the second fluid chamber 2 (comprising the testing chamber). In such configurations, as the fluid balancing chamber 3 is positioned beneath the fluid balancing chamber 4, the support legs 15 are coupled to the bottom surface of the fluid balancing chamber 3. Any such alternative configurations of the testing device are intended to be included within the scope of the present disclosure, provided that the sealing ring 22, through which loading rod 7 is inserted, enters the first fluid chamber 1 (which is not the testing chamber), and provided that the sealing ring 22 is not connected to a chamber wall of the second fluid chamber (which is the testing chamber).

### Operation of the Testing Device

It is known that long-term material mechanical property testing in a high-pressure environment faces at least the following technical challenges: 1) maintaining the desired pressure within the testing chamber; 2) maintaining the purity of the testing environment agent, which may be hydrogen gas for example, without contamination of the testing environment agent; and 3) accurate measurement of the mechanical property being tested. These technical challenges are particularly challenging for long-term testing in a high-pressure hydrogen gas environment, since the relatively small hydrogen gas molecules are especially prone to leakage, and may be readily contaminated by other substances leaking into the testing chamber, such as hydraulic oil. In order to prevent the testing agent in the testing chamber from leaking in known prior art testing devices, very tight sealing between the loading rod and the testing chamber may typically be implemented. However, this tight sealing may introduce high friction forces between the movable loading rod and the sealing element, which may result in inaccurate measurement of the load force applied to the material specimen being tested.

The presently disclosed testing devices resolve the above technical challenges by introducing a testing environment chamber with a design of two-disc diaphragms and four chambers as described herein. Advantageously, this design facilitates complete isolation of the testing chamber from contamination sources, such as hydraulic or lubricating oil, by removing the need to have the loading rod 7 pass through a sealing element that is mounted to any wall or surface that defines the testing chamber. In particular, the sealing assembly 30 provides for the loading rod 7 to be fixedly mounted to, and sealed against, the diaphragm 5, such that the loading rod 7 is not moving relative to the diaphragm 5. Instead, the relative movement of the loading rod 7, relative to the material specimen 9, is accomplished by the deflection of the disc diaphragm 5, to which the loading rod 7 is fixedly mounted. Thus, leakage of the testing environment agent, such as hydrogen gas, may be substantially reduced or prevented since the testing chamber 2 containing the hydrogen gas is effectively sealed by the sealing assembly 30.

Furthermore, the sealing ring or sealing element 22, which allows the loading rod 7 to pass into and out of the first fluid chamber 1, may help substantially reduce the friction between the loading rod 7 and the sealing element 22. The friction force acting on the loading rod 7 may be further reduced when the first fluid 1 is a lubricating fluid, such as a hydraulic oil or a lubricating oil, as the loading rod 7 is immersed in the lubricating fluid contained within the first fluid chamber 1 as the loading rod 7 moves into and out of the first fluid chamber 1. This reduction of the friction forces acting on the loading rod 7 improves the accuracy of the measurement of the load transmitted to the material specimen 9 by the loading rod 7.

As well, the pair of fluid balancing chambers 3, 4, connected to the respective fluid chambers 1, 2 via fluid conduits 10, 11, allows for maintaining consistent pressure in each of the chambers. The configuration of fluid balancing chambers may keep the pressure consistent and equal between the chambers. In particular, in the embodiment as discussed above with reference to FIGS. 1-8, only hydraulic lubricating oil exists in the first fluid chamber 1 located above the second fluid chamber. The macromolecular structure of the hydraulic oil in the first fluid chamber is not prone to leakage, due to the tight sealing between the loading rod 7 and the sealing ring 22. Meanwhile, the friction force is greatly reduced between the hydraulic oil chamber 1 and the loading rod 7 by the lubrication effect, reducing the friction acting on the as the loading rod 7 moves through the sealing ring 22. Because the first disc diaphragm 5 and the second disc diaphragm 6 are highly flexible, the membrane force caused by small deformations on the first disc diaphragm 5 and the second disc diaphragm 6 may be ignored. Alternatively, the membrane force on the first disc diaphragm 5 and on the second disc diaphragm 6 may be accurately calculated for large displacement testing and taken into account when measuring the loads applied to the material specimen by the loading rod 7. More practically, for each combination of particularly selected diaphragm 5 and diaphragm 6, any additional force imposed to loading rod 7 due to diaphragm deformation may be tested and pre-determined prior to performing mechanical property testing on a specimen.

As the first fluid chamber 1, the high-pressure testing environment chamber 2, the hydraulic oil balancing chamber 3 and the environment testing fluid balancing chamber 4 are all effectively sealed, they may hold high pressure fluids or gases within these chambers. Both the first disc diaphragm 5 and the second disc diaphragm 6 may be constructed of highly flexible metal sheets or other strong and flexible materials suitable for the testing device disclosed herein, which disc diaphragms readily deform in response to pressure changes in the two chambers arranged on opposite sides of the disc diaphragm and/or in response to the motion of the loading rod 7. The second disc diaphragm 6 is capable of synchronously deforming in response to the pressure changes in the first fluid chamber 1 and the high-pressure testing environment chamber 2 because of the free flowing movement of the first fluid between the first fluid chamber 1 and the first fluid balancing chamber 3 via the first connecting conduit 10, and the free flowing movement of the hydrogen gas (or other pressurized fluid) between the high pressure testing environment chamber 2 and the second fluid balancing chamber 4 via the second connecting conduit 11. Thus, the up-down pressure fluctuations that occur in the first fluid chamber 1 and the high pressure testing environment chamber 2 are compensated by the corresponding pressure balancing chambers 3 and 4, thereby maintaining a relatively consistent pressure in each of the first and second fluid chambers 1 and 2. Therefore, the load applied to the material specimen 9, transmitted by the loading rod 7, may be accurately determined because there is no (or minimal) additional load added to the loading rod by the movement of the first disc diaphragm 5.

The examples of the testing device in the foregoing description are provided to illustrate the operating principles of the testing device, but it will be appreciated that the novel testing device disclosed herein is not limited to the specific examples described herein, and that variations on the proposed concepts disclosed herein are intended to be included in the present disclosure. Further, since numerous changes and modifications will readily occur to those skilled in the art, it is not intended to limit the scope of the invention to the exact construction and operation shown and described, and accordingly, all such suitable changes or modifications in structure or operation which may be resorted to are intended to fall within the scope of the claimed invention.

1. A testing device for testing mechanical properties of a material specimen in a pressurized testing environment comprising:
a first fluid chamber for containing a first fluid;
a second fluid chamber for containing a second fluid to provide the pressurized testing environment;
a first disc diaphragm separating the first fluid chamber from the second fluid chamber and fixedly mounted together with the first fluid chamber and the second fluid chamber;
a first fluid balancing chamber in fluid communication with the first fluid chamber;
a second fluid balancing chamber in fluid communication with the second fluid chamber;
a second disc diaphragm separating the first fluid balancing chamber from the second fluid balancing chamber and fixedly mounted together with the first fluid balancing chamber and the second fluid balancing chamber;
a loading rod extending through a wall of the first fluid chamber and the first disc diaphragm for applying a predetermined force on the material specimen in the second fluid chamber;
a sealing element fixedly coupled to the wall of the first fluid chamber to allow the loading rod to slide through the sealing element; and
a sealing assembly fixedly mounted together with the loading rod and the first disc diaphragm to seal the first fluid chamber from the second fluid chamber.

2. The testing device of claim 1 wherein the sealing assembly comprises:
a lower sealing disc located below the first disc diaphragm and fixedly mounted to the loading rod;
at least one first sealing gasket mounted between the lower sealing disc and the first disc diaphragm;
an upper sealing disc located above the first disc diaphragm and fixedly mounted together with the lower sealing disc and the first disc diaphragm; and
at least one second sealing gasket mounted between the upper sealing disc and the first disc diaphragm.

3. The testing device of claim 2 wherein the lower sealing disc is welded to the loading rod.

4. The testing device of claim 2 wherein the lower sealing disc is manufactured together with the loading rod as one piece.

5. The testing device of claim 2 wherein the upper disc, the first disc diaphragm and the lower disc are fixedly mounted together by a plurality of fasteners.

6. The testing device of claim 2 wherein each of the at least one first sealing gasket and the at least one second sealing gasket comprises an inner annular sealing gasket located between the plurality of fasteners and the loading rod and an outer annular sealing gasket located between the plurality of fasteners and an outer edge of the upper and lower sealing discs.

7. The testing device of claim 1 wherein the first fluid is an oil, and the second fluid is hydrogen gas.

8. The testing device of claim 1 wherein the second fluid chamber is located below the first fluid chamber, and the second fluid balancing chamber is located below the first fluid balancing chamber.

9. The testing device of claim 1 wherein each of the first fluid chamber, the second fluid chamber, the first fluid balancing chamber and the second fluid balancing chamber are cylindrical in shape.

10. The testing device of claim 1 further comprising a specimen support structure fixedly mounted onto an inner surface of a wall of the second fluid chamber.

11. The testing device of claim 1 further comprising a first connecting conduit fluidly connecting the first fluid chamber to the first fluid balancing chamber, and a second connecting conduit connecting the second fluid chamber to the second fluid balancing chamber.

12. The testing device of claim 1 further comprising a first inlet conduit coupled to an inlet of the first fluid chamber and a first outlet conduit coupled to an outlet of the first fluid balancing chamber.

13. The testing device of claim 1 further comprising a second inlet conduit coupled to an inlet of the second fluid chamber and a second outlet conduit coupled to an outlet of the second fluid balancing chamber.

14. The testing device of claim 12 wherein each of the first inlet conduit and the first outlet conduit include a valve for controlling the flow of the first fluid through the first inlet conduit and the first outlet conduit.

15. The testing device of claim 13 wherein each of the second inlet conduit and the second outlet conduit include a valve for controlling the flow of the second fluid through the second inlet conduit and the second outlet conduit.

16. The testing device of claim 1 wherein each of the first fluid chamber, the first fluid balancing chamber, the second fluid chamber and the second fluid balancing chamber has a flange extended outwardly from its chamber body so that the first fluid chamber is fixedly mounted together with the second fluid chamber by a first plurality of chamber fasteners inserted through the first and second fluid chambers' corresponding flanges, and the first fluid balancing chamber is fixedly mounted together with the second fluid balancing chamber by a second plurality of chamber fasteners inserted through the first and second fluid balancing chambers' corresponding flanges.

17. The testing device of claim 1 further comprising at least one diaphragm sealing gasket sandwiched between each of the first disc diaphragm and the second disc diaphragm and the corresponding first or second fluid chambers or the corresponding first or second fluid balancing chambers.

18. The testing device of claim 1 further comprising a plurality of supporting legs for stably supporting at least the second fluid chamber and the second fluid balancing chamber on a surface.

19. The testing device of claim 1 further comprising at least one connecting rod for stably connecting at least the second fluid chamber on a surface of a material mechanical testing machine.
